(19) United States
(12) Patent Application Publication
(10) Pub. No.: US 2004/0101111 A1
(43) Pub. Date: May 27, 2004

(54) Phone jack for telephone test set

(76) Inventor: Teresa M. Maldonado, Los Angeles, CA (US)

Correspondence Address: Donald W. Meeker, 750 La Playa, #512, San Francisco, CA, 94121, US

(21) Appl. No.: 10/302,616

(22) Filed: Nov. 23, 2002

(51) Int. Cl. H04M 1/24; H04M 3/08; H04M 3/22

(52) U.S. Cl. 379/26.01; 379/27.07

(57) ABSTRACT

A telephone plug-in jack or pair of jacks are attached with one on each side of the casing on a telephone test set. The telephone plug-in jacks are telephonically connected to the telephone test set clips which attach to telephone lines. Computer modems and other equipment with telephone plugs may be plugged into the test set for outside telephone access when the clips are attached to the telephone wires.

### BACKGROUND OF THE INVENTION

1. Field of the Invention

The present invention relates to telephone testing equipment and in particular to a telephone test set having an extra telephone jack built into the casing of the telephone test set to enable a tester to plug a telephone or modem into the test set while the test set is clipped to a telephone line.

2. Description of the Prior Art

In the field, telephone technicians are equipped with telephone test sets for testing telephone lines while on an installation or repair job. The test set generally uses clamps to clip onto a telephone line and test the line by placing a call on the line and having the telephone office participate in the checking of the line. This testing occurs at a location where the wires come into a building in a basement or other utility room location where there are no phone jacks.

The telephone technician also needs to use a laptop computer for communicating on the internet in connection with the work being performed. Also there may be a need to test the line for utilization with other types of telephone plug-in equipment, such as FAX machines or other telephone equipment. Currently there is difficulty in finding a phone jack to plug in the laptop modem or other telephone plug-in type equipment.

While there have been other types of equipment provided with phone jacks, they do not include the telephone test set used by telephone repairmen.

U.S. Pat. No. 5,755,590, issued May 26, 1998 to Zoiss, discloses a strain relief attachment for attaching a telephone communication cord to a telephone test set has a line cord strain relief element, a grooved neck end of which is insertable through a tunnel through an end of the test set to a strain relief engagement cavity adjacent to a battery compartment of the test set and accessible by a battery door. The strain relief element includes a bore through which the line cord extends and a flange configured to conform with an external surface of the test set adjacent to the tunnel. The strain relief element engagement cavity is connected by a line cord passageway to the battery compartment. A wedge-shaped line cord retention plug is inserted into the strain relief engagement cavity, engaging the grooved neck of the line cord strain relief element and a wall surface of the strain relief engagement cavity. As the wedge-shaped line cord retention plug is inserted into the cavity, it draws the line cord strain relief element into the test set, urging the flange of the line cord strain relief element into sealing engagement with the external surface of the test set.

U.S. Pat. No. 5,170,429, issued Dec. 8, 1992 to Stocklin, provides a handheld, battery-powered telecommunications test instrument with a talk battery circuit capable of supplying power for up to four telephone sets, which may be connected either in series or in parallel. The instrument determines the configuration of the telephone sets as having serial connections or parallel connections by sensing the amount of current flowing through the circuit of the invention. In response to the amount of current, a transistor automatically operates to supply power to the telephone sets as either a voltage source or a current source and maximizes power transfer between the telephone sets. The instrument has a low power mode to reduce current drain on

the battery that is automatically engaged when the telephone sets are not in use.

U.S. Pat. No. 4,602,134, issued Jul. 22, 1986 to Atkinson, shows a software-controlled telephone tester that permits untrained consumers to test telephone sets by connecting the line cord to the tester and following simple instructions which are sequentially displayed on a panel. Tests are automatically performed after each instruction to provide objective determinations of the operability of the telephone under test. Tested parameters which fall outside specification result in a failure indication. If the user fails to effect certain instructions properly, a “try again” instruction is generated. Transmission tests are effected automatically by placing the telephone earpiece and/or mouthpiece adjacent a transducer and transmitting at least one tone from the tester through the telephone and back to the tester. Preferably a two-tone test is employed using a pair of the standard DTMF signaling tones so that transmission testing is effected using the same circuitry employed for DTMF dial testing. The tester transducer is recessed behind the tester panel to reduce the effect of amplitude variations caused by small positional differences in the placing of the mouthpiece/earpiece adjacent the transducer.

U.S. Pat. No. 4,837,811, issued Jun. 6, 1989 to Butler, describes an improved craft technician's field terminal of the portable, hand-held type for use in communicating in diverse modes with a central technician access network. The terminal is connected to the telephone line in conventional manner in communication with the telephone access network. Job data can then be transmitted from the central network and downloaded to the terminal for instantaneous display. Re-transmission can be requested if needed. The terminal is capable of uploading data from the terminal display in either DTMF and/or ASCII to the central network. The craft technician's terminal contains a much greater storage capacity than any similar devices heretofore and it is capable of holding job order and response data for what amounts to greater than a full days technician work. In addition, data displayed at the terminal may readily be transmitted for printer access while still being retained in the terminal storage.

U.S. Pat. No. 5,687,213, issued Nov. 11, 1997 to Larkin, indicates a telephone line tester includes a pin socket connector, a modular jack connector and a plurality of lines out. The telephone line tester can be connected to a telephone line at a modular jack interface, and alternatively, at a pin socket interface. Testing can be performed by accessing signals of the telephone line through the plurality of lines out. Testing can also be performed by accessing signals of the telephone line through the modular jack connector.

What is needed is a telephone test set equipped with a telephone plug-in jack.

### SUMMARY OF THE INVENTION

An object of the present invention is to provide a telephone test set with one or more telephone plug-in jacks to enable a telephone repairperson to plug computer modems or other telephone related equipment requiring a telephone plug-in jack.

Another object of the present invention is to provide a telephone test set with one or more telephone plug-in jacks to save time in being able to plug in a laptop computer while the test set is clipped onto the telephone wires in a utility room or basement rather than having to find a telephone jack elsewhere in the building.

In brief, a telephone test set carried by telephone repair people and installers is supplied with one or more telephone plug-in jacks connected to the phone line clips of the test set so that when the clips are attached to telephone lines a telephone device or modem may be plugged into the test set telephone jack for a telephonic connection.

An advantage of the present invention is that it provides a telephone jack connection wherever a telephone technician has access to connect to telephone wires, on a telephone pole or in a basement or a utility room where there would normally be no telephone jack.

Another advantage of the present invention is that it saves considerable time for telephone installers and repair people to have an instant telephone jack for computer modems and other telephone type equipment.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view showing a telephone test set equipped with two telephone jacks built into the telephone test set case.

### BEST MODE FOR CARRYING OUT THE INVENTION

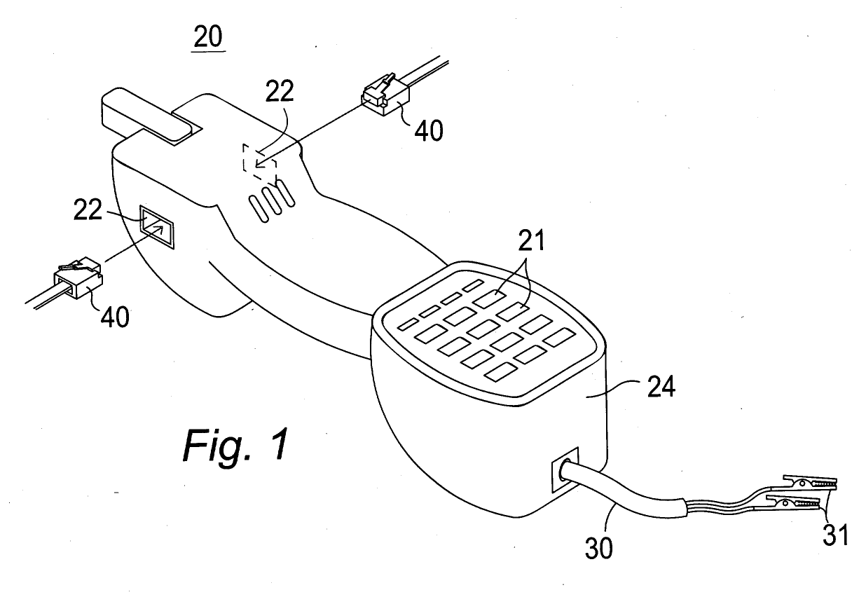

In FIG. 1 a telephone test set device 20 has a telephone plug-in jack 22 or preferably a pair of telephone plug-in jacks 22 attached preferably with one on each side of the test set at one end of the test set as shown in FIG. 1 or to a flat bottom exterior portion 24 of the telephone test set adjacent to the wire 30 having the clips 31 which are the means for attaching the telephone test set to telephone wires to create a telephone connection between the telephone test set and the global telephone network.

The telephone plug-in jacks 22 are telephonically connected to the clips 31 so that the at least one telephone plug-in jack is connected to the global telephone network when the clips are connected to the telephone wires. The telephone plug-in jacks are accessible from the exterior of the telephone test set and are capable of receiving telephone plugs 40 therein.

Computer modems from a telephone repair person's laptop computer and any other equipment with telephone plugs may be plugged into the test set when the clips are attached to the telephone wires and the computer and other equipment thereby connected to the global telephone network. The buttons 21 or other controls on the test set function in the normal fashion.

It is understood that the preceding description is given merely by way of illustration and not in limitation of the invention and that various modifications may be made thereto without departing from the spirit of the invention as claimed.

What is claimed is:

1. A telephone test set device having a telephone jack plug-in capability, the device comprising:
a telephone test set having a means for attaching the telephone test set to telephone wires to create a telephone connection between the telephone test set and the global telephone network;
at least one telephone plug-in jack telephonically connected to the means for attaching the telephone test set to telephone wires so that the at least one telephone plug-in jack is connected to the global telephone network when the means for attaching the telephone test set to telephone wires is connected to the telephone wires, the at least one telephone plug-in jack being attached to the telephone test set so that the telephone plugin jack is accessible from the exterior of the telephone test set and is capable of receiving a telephone plug therein.

2. The device of claim 1 wherein the means for connecting the telephone test set to telephone wires comprises a pair of clips.

3. The device of claim 1 wherein two telephone plug-in jacks are attached to an exterior casing of the telephone test set and telephonically connected to the means for telephonically connecting the telephone test set to the global telephone network.

4. The device of claim 3 wherein the two telephone plug-in jacks are attached to an exterior casing of the telephone test set with one on each side of the exterior casing of the telephone test set.
